(19) United States
(12) Patent Application Publication
(10) Pub. No.: US 2009/0049623 A1
(43) Pub. Date: Feb. 26, 2009

(54) Method for Preventing Color Loss in Oxidatively Dyed Hair

(76) Inventors: Mark Anthony Brown, Union, KY (US); Thomas Allen Hutchins, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/189,965

(22) Filed: Aug. 12, 2008

Related U.S. Application Data
(63) Continuation-in-part of application No. 11/894,144, filed on Aug. 20, 2007.
(60) Provisional application No. 61/057,796, filed on May 30, 2008.

(51) Int. Cl. D06P 5/08; A61Q 5/12; B65D 85/00; G06Q 30/00

(52) U.S. Cl. 8/442; 132/208; 206/459.5; 705/14

(57) ABSTRACT

A method for preventing color loss from oxidatively dyed hair comprising the steps of: a) contacting said hair with a shampoo composition, said shampoo comprising: from about 5% to about 50% of an anionic surfactant; from about 0.025% to about 5% by weight of a synthetic cationic polymer having a cationic charge density of at least about 3 meq/gm, wherein said synthetic cationic polymer form lyotropic liquid crystals upon combination with said anionic surfactant; and water; and b) rinsing said composition from said hair. An article of manufacture comprises the shampoo composition and is promoted to consumers.

### CROSS REFERENCE TO RELATED APPLICATIONS

This application claims the benefit of U.S. Provisional application No. 61/057,796 filed May 30, 2008 and is a continuation-in-part of prior U.S. application Ser. No. 11/894144, filed Aug. 20, 2007.

### FIELD OF THE INVENTION

The present invention relates to a method for preventing color loss in oxidatively dyed hair by applying a shampoo composition which contains lyotropic liquid crystals to the hair, as well as to articles of manufacture comprising the shampoo composition, and methods of promoting the sale thereof.

### BACKGROUND OF THE INVENTION

Hair dyes are formulated to give hair long-lasting and richly hued colors, but several factors—from mechanical to environmental—can accelerate color changes and fading.

The cuticle is the primary protection for the hair cortex, where the majority of color molecules are housed. If friction or excessive chemical treatments damage the cuticle and strip away its protective fatty (hydrophobic) layer, the exposed cortex will chip away, and color molecules will escape during shampooing. During the hair dyeing process, particularly during the course of oxidative dyeing, increased exposure to peroxide generally causes greater cuticle damage, and therefore increases the hair's susceptibility to color loss. Protection of the cuticle with shampoos and conditioners that contain friction-reducing silicones provides some limited aid against color loss. However, friction reduction protects against further damage to the cuticle more effectively than preventing color fade.

When the cuticle is damaged, the primary cause of color fading is due to the hair's contact with water. When the cuticle is overly compromised, water can more easily enter the cortex and some of the color molecules can be pulled out and washed away. It is often thought that shampoo products are primarily responsible for color loss from damaged cuticles. However, water, and generally not the shampoo, causes color loss during the shampooing process.

Based on the foregoing, there is a need for a method for preventing color loss in oxidatively dyed hair through the application of a shampoo product which not only does not strip color from hair, but instead provides enhanced efficacy and performance for preventing color loss from hair fibers. Furthermore, there is a need for a method of communicating to a consumer the ability of a shampoo composition to prevent color loss from oxidatively dyed hair.

### SUMMARY OF THE INVENTION

The present invention relates to a method for preventing color loss from oxidatively dyed hair, comprising the steps of:

a) contacting said hair with a shampoo composition, said shampoo composition comprising:

i from about 5% to about 50% of an anionic surfactant;

ii from about 0.025% to about 5% by weight of a synthetic cationic polymer having a cationic charge density of greater than or equal to about 3 meq/gm, wherein said synthetic cationic polymer forms lyotropic liquid crystals upon combination with said anionic surfactant; and

iii water; and

b) rinsing said composition from said hair.

The present invention also relates to an article of manufacture useful for preventing color loss from oxidatively dyed hair, comprising (a) a package; (b) said package containing a shampoo composition, wherein said shampoo composition comprises lyotropic liquid crystals; and (c) information to communicate the color loss prevention ability of the shampoo composition to consumers.

The present invention also relates to methods of promoting the sale of shampoo compositions which are useful for preventing color loss from oxidatively dyed hair. The methods include a variety of steps to inform a consumer of the color loss prevention ability of the present shampoo compositions and articles, and encourage the consumer to use them to prevent color loss from hair.

### DETAILED DESCRIPTION OF THE INVENTION

It has been surprisingly discovered that compositions which form lyotropic liquid crystals are particularly useful in preventing color loss from oxidatively dyed hair.

A liquid crystalline state exists structurally between the solid crystalline phase and the liquid phase (i.e. an intermediate between the three dimensionally ordered crystalline state and the completely disordered liquid state).

The term “liquid crystal” as used herein, means a material having phases that are ordered and/or crystalline in only one or two of their three possible orthogonal directions and are disordered (random and/or liquid-like ) in the other dimensions.

The term “lyotropic” as used herein, means that the ordering effects of a material are induced by changing both its concentration and temperature.

The term “nonvolatile” refers to any material having little or no significant vapor pressure under ambient conditions, and a boiling point under one atmosphere (atm) preferably at least about 250° C. The vapor pressure under such conditions is preferably less than about 0.2 mm.

The term “polymer” as used herein, shall include materials whether made by polymerization of one type of monomer or made by two (i.e., copolymers) or more types of monomers.

The term “water soluble” as used herein, means that the polymer is soluble in water in the present composition. In general, the polymer should be soluble at 25° C. at a concentration of 0.1% by weight of the water solvent, preferably at 1%, more preferably at 5%, more preferably at 15%.

All percentages, parts and ratios are based upon the total weight of the compositions of the present invention, unless otherwise specified. All such weights as they pertain to listed ingredients are based on the active level and therefore do not include solvents or by-products that may be included in commercially available materials, unless otherwise specified.

The shampoo compositions can comprise, consist of, or consist essentially of the essential elements and limitations of the invention described herein, as well any of the additional or optional ingredients, components, or limitations described herein.

All molecular weights as used herein are weight average molecular weights expressed as grams/mole, unless otherwise specified.

Method for Preventing Color Loss from Oxidatively Dyed Hair

The compositions described herein are particularly useful in preventing color loss from hair which has been previously treated with an oxidative dye. Hair which has previously been treated with an oxidative dye is believed to particularly benefit from treatment with the compositions herein because this process damages hair due to the use of peroxide in the hair dyeing treatment. “Oxidatively dyed” or “previously oxidatively dyed” hair includes hair which contains hair dye molecules resulting from an oxidative hair dyeing process or otherwise visually exhibits a hair color which is the result of an oxidative hair dye treatment. “Oxidatively dyed” or “previously oxidatively dyed” hair further includes hair which has been oxidatively dyed, and results in a hair color which is similar in shade or color to the user's natural hair color. Such dyeing techniques are often used to enhance richness or to counteract graying of hair.

As discussed hereinbefore, it is generally thought that shampoo compositions wash color from hair fibers. However, the method of the present invention utilizes a shampoo composition which prevents color loss from oxidatively dyed hair. More specifically, the shampoo compositions herein provide the hair with a protective hydrophobic layer, which prevents color molecules from being lost from hair when the open or damaged cuticle is exposed to water.

The method of preventing color loss herein comprises the steps of contacting hair, which has previously been oxidatively dyed, with an effective amount of the shampoo composition herein for cleansing, conditioning, and preventing color loss of the previously oxidatively dyed hair, which has preferably been wetted with water. After contacting the preferably wet hair with the shampoo composition, the composition is rinsed from the hair. Effective amounts of the shampoo generally range from about 1 gm to about 50 gm, preferably from about 1 gm to about 20 gm. Application to the hair typically includes working the composition through the hair such that most or all of the hair is contacted with the composition.

Article of Manufacture for Preventing Color Loss from Oxidatively Dyed Hair

The present invention also relates to an article of manufacture useful for preventing color loss from hair, the hair having previously been oxidatively dyed. The article comprises a package which contains the shampoo composition described hereinafter. The package is in association with information or instructions, in the form of indicia, which informs the consumer that the shampoo composition will prevent color loss from oxidatively dyed hair. The indicia may be in the form of words, pictures, symbols, or the like. Furthermore, the package may include a claim of superiority over other shampoo compositions. As many consumers associate shampoo products with color loss, it is important to provide information or instructions as to the ability of the shampoo composition to prevent color loss in oxidatively dyed hair. As used herein, the phrase, “in association with”, means the information or instructions are either directly printed on the package itself, or presented in a different manner including, but not limited to, promotional material, so as to communicate the information or instructions to a consumer of the article of manufacture. The information or instructions are important to encourage consumers, especially those who frequently dye their hair, to use the shampoo composition described herein.

In another embodiment, the package may bear information that informs the consumer that the shampoo composition provides one or more benefit selected from providing hair with a protective hydrophobic layer, improving color uptake, restoring hair to a virgin-like state, or combinations thereof. The lyotropic liquid crystals present in the shampoo compositions herein have been found to provide these and other benefits to previously oxidatively dyed hair.

The package should be any package suitable for containing liquid compositions. In the case of shampoo compositions, such packages are typically formed from petroleum-based plastics such as PET.

Method of Promoting the Sale of Article of Manufacture for Preventing Color Loss from Oxidatively Dyed Hair

The present invention also relates to methods for promoting the sale of the aforementioned articles of manufacture. The present methods generally comprise providing promotional materials to consumers by a variety of steps to inform them of the color loss prevention benefits of the present shampoo compositions, and particularly to communicate the function of lyotropic liquid crystals in preventing color loss from oxidatively dyed hair.

The present methods are especially important to provide long lasting color for consumers who oxidatively dye their hair. The consumers will be informed of the color loss prevention benefits of the present shampoo compositions, and will be motivated to use them to prevent color loss from hair. Upon identifying and using the shampoo compositions herein, the consumer will enjoy long lasting color, more virgin-like hair, and improved overall hair health. This helps consumers to identify a specific shampoo or article of manufacture for the purpose of preventing color loss, as well as the other aforementioned benefits.

In one embodiment, the method comprises promoting the sale of a shampoo product which contains lyotropic liquid crystals, comprising the steps of (a) displaying, shelving, or merchandising the shampoo product in a retail store; and/or (b) providing promotional materials to consumers, wherein said promotional materials comprise information regarding the shampoo product's ability to prevent color loss from oxidatively dyed hair and/or an instruction to apply the shampoo product to hair which has been oxidatively dyed.

In another embodiment, the method includes sending promotional materials directly to consumers via mail or electronic mail. The promotional materials can also include samples of the shampoo compositions herein, or articles, and can include discount coupons which the consumer can redeem upon purchasing the present shampoo compositions or articles.

In yet another embodiment, the method includes providing promotional materials to a hair styling salon, which is intended to encourage the stylist to provide the promotional materials or information to his or her customers, preferably to customers with oxidatively dyed hair. Since a customer and/or consumer with oxidatively dyed hair may have the hair dyeing process conducted by a professional stylist, this method of promoting the sale of the present shampoo compositions or articles is particularly effective, because these consumers typically entrust stylists with particular expertise regarding hair treatment compositions and regimens. It is believed that such stylists would be enabled to effectively communicate the benefits of lyotropic liquid crystals to their customers—preferably customers with oxidatively dyed hair—upon receipt and review of the promotional materials of the present invention.

### Shampoo Composition

As discussed hereinbefore, the present invention includes a shampoo composition which contains lyotropic liquid crystals. The liquid crystals may form upon combination of the detersive surfactant component and cationic polymer discussed hereinafter. It has been surprisingly discovered that application of the shampoo composition herein to hair prevents color loss in oxidatively dyed hair, as well as other benefits.

Detersive Surfactant Component

The shampoo compositions for preventing color loss from oxidatively dyed hair comprise an anionic detersive surfactant component to provide cleaning performance to the composition, and to aid in formation of the lyotropic liquid crystalline phase. The detersive surfactant component comprises an anionic detersive surfactant, and optionally, a zwitterionic and/or amphoteric detersive surfactant which has an attached group that is anionic at the pH of the composition. Such surfactants should be physically and chemically compatible with the essential components described herein, or should not otherwise unduly impair product stability, aesthetics or performance.

Suitable anionic detersive surfactant components include those which are known for use in hair care or other shampoo cleansing compositions. The concentration of the detersive surfactant component generally ranges from about 5% to about 50%, preferably from about 8% to about 30%, more preferably from about 10% to about 25%, even more preferably from about 12% to about 20%, by weight of the composition.

Preferred anionic detersive surfactants for use in the shampoo compositions include ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, potassium lauryl sulfate, triethanolamine lauryl sulfate, triethanolamine lauryl sulfate, monoethanolamine cocoyl sulfate, monoethanolamine lauryl sulfate, sodium tridecyl benzene sulfonate, sodium dodecyl benzene sulfonate, and combinations thereof.

Suitable amphoteric or zwitterionic detersive surfactants for use in the shampoo composition herein include those which are known for use in hair care or other personal care cleansing composition, and which contain a group that is anionic at the pH of the shampoo composition. The concentration of such amphoteric detersive surfactants preferably ranges from about 0.5% to about 20%, preferably from about 1% to about 10%, by weight of the composition. Non-limiting examples of suitable zwitterionic or amphoteric surfactants are described in U.S. Pat. Nos. 5,104,646 and 5,106,609.

The shampoo compositions may further comprise additional surfactants for use in combination with the anionic detersive surfactant component described hereinbefore. Suitable optional surfactants include nonionic surfactants, cationic surfactants, and combinations thereof. Any such surfactant known in the art for use in hair or personal care products may be used, provided that the optional additional surfactant is also chemically and physically compatible with the essential components of the shampoo composition, or does not otherwise unduly impair product performance, aesthetics or stability. The concentration of optional additional surfactants in the shampoo composition may vary with the cleansing or lather performance desired, the optional surfactant selected, the desired product concentration, the presence of other components in the composition, and other factors well known in the art.

Non limiting examples of other anionic, zwitterionic, amphoteric or optional additional surfactants suitable for use in the shampoo compositions are described in U.S. Pat. Nos. 3,929,678; 2,658,072; 2,438,091; and 2,528,378.

Synthetic Cationic Polymer

Since cuticle integrity is critical to maximizing color uptake and retention, the cationic polymer herein helps provide oxidatively dyed hair with a surrogate hydrophobic F-layer. The microscopically thin F-layer provides natural weatherproofing while helping to seal in color and moisture and help prevent further damage. Hair's natural F-layer is lost when it is oxidatively dyed. It has been found that oxidatively dyed hair, to which lyotropic liquid crystals are applied, becomes more hydrophobic and returns the treated hair to its more virgin hair state in both look and feel. Without being limited to theory, it is believed that the lyotropic liquid crystal complex creates a hydrophobic layer or film, which coats the hair fibers, and protects the hair from color loss due to contact with water. The hydrophobic layer returns the hair to a generally virgin-like, and healthier, state. Healthier hair takes color more evenly during future color treatments and keeps the color richer for a longer period of time. Therefore, the hydrophobic layer aids in both color uptake and retention in hair, as well as returning the hair to a healthier and virgin-like state.

Lyotropic liquid crystals are formed by combining the synthetic cationic polymers herein with the aforementioned anionic detersive surfactant component of the shampoo composition. The synthetic cationic polymer has a relatively high charge density. It should be noted that some synthetic polymers having a relatively high cationic charge density do not form lyotropic liquid crystals primarily to their abnormal linear charge densities. Such synthetic cationic polymers are described in WO 94/06403 to Reich et al. The synthetic polymers herein can be formulated in a stable shampoo composition that provides improved hair color retention and conditioning performance. In one embodiment, the synthetic cationic polymer may be formed from

i) one or more cationic monomer units, and optionally

ii) one or more momomer units bearing a negative charge, and/or

iii) a nonionic momomer,

wherein the subsequent charge of the copolymer is positive. The ratio of the three types of monomers is given by “m”, “p” and “q” where “m” is the number of cationic monomers, “p” is the number of momomers bearing a negative charge and “q” is the number of nonionic momomers.

The concentration of the cationic polymers ranges about 0.025% to about 5%, preferably from about 0.1% to about 3%, more preferably from about 0.2% to about 1%, by weight of the shampoo composition.

The cationic polymers have a cationic charge density of at least about 3 meq/gm or at least about 5 meq/gm. The polymers further have a cationic charge density with is less than about 10 meq/gm, or less than about 7 meq/gm. In one embodiment, the cationic charge density is about 6.2 meq/gm. The polymers also have a molecular weight of at least about 500,000 to about 5,000,000, more preferably from about 500,000 to about 2,000,000.

In one embodiment, the cationic polymers are water soluble or dispersible, non-crosslinked, synthetic cationic polymers having the following structure:

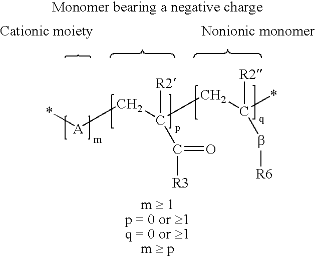

Where A, may be one or more of the following cationic moieties:

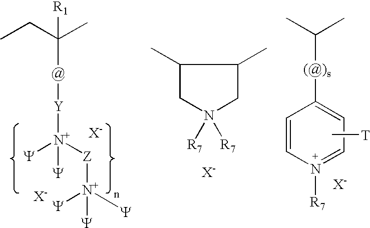

Where @=amido, alkylamido, ester, ether, alkyl or alkylaryl.
Where Y=C1-C22 alkyl, alkoxy, alkylidene, alkyl or aryloxy.
Where ψ=C1-C22 alkyl, alkyloxy, alkyl aryl or alkyl aryloxy.
Where Z=C1-C22 alkyl, alkyloxy, aryl or aryloxy.
Where R1=H, C1-C4 linear or branched alkyl.
Where s=0 or 1, n=0 or ≧1.
Where T and R7=C1-C22 alkyl.
Where X−=halogen, hydroxide, alkoxide, sulfate or alkylsulfate.

Where the monomer bearing a negative charge is defined by R2′=H, C1-C4 linear or branched alkyl and R3 as:

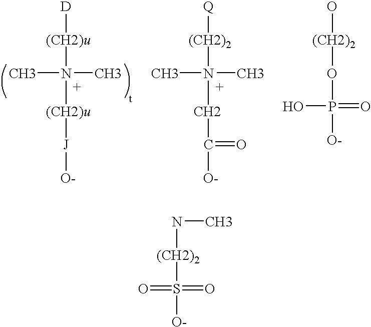

Where D=O, N, or S.
Where Q=NH₂ or O.
Where u=1-6.
Where t=0-1.
Where J=oxygenated functional group containing the following elements P, S, C.

Where the nonionic monomer is defined by R2″=H, C1-C4 linear or branched alkyl, R6 =linear or branched alkyl, alkyl aryl, aryl oxy, alkyloxy, alkylaryl oxy and β is defined as

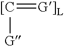

Where G′ and G″ are, independently of one another, O, S or N—H and L=0 or 1.

Examples of cationic monomers include aminoalkyl (meth)acrylates, (meth)aminoalkyl (meth)acrylamides; monomers comprising at least one secondary, tertiary or quaternary amine function, or a heterocyclic group containing a nitrogen atom, vinylamine or ethylenimine; diallyldialkyl ammonium salts; their mixtures, their salts, and macromonomers deriving from therefrom.

Further examples of cationic monomers include dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide, ethylenimine, vinylamine, 2-vinylpyridine, 4-vinylpyridine, trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido chloride, trimethyl ammonium propyl (meth)acrylamido chloride, vinylbenzyl trimethyl ammonium chloride, diallyldimethyl ammonium chloride.

Preferred cationic monomers comprise quaternary ammonium group of formula —NR₃⁺, wherein R, which is identical or different, represents a hydrogen atom, an alkyl group comprising 1 to 10 carbon atoms, or a benzyl group, optionally carrying a hydroxyl group, and comprise an anion (counter-ion). Examples of anions are halides such as chlorides, bromides, sulphates, hydrosulphates, alkylsulphates (for example comprising 1 to 6 carbon atoms), phosphates, citrates, formates, and acetates.

Preferred cationic monomers include trimethylammonium ethyl (meth)acrylate chloride, trimethylammonium ethyl(meth)acrylate methyl sulphate, dimethylammonium ethyl(meth)acrylate benzyl chloride, 4-benzoylbenzyl dimethylammonium ethyl acrylate chloride, trimethyl ammonium ethyl(meth)acrylamido chloride, trimethyl ammonium propyl(meth)acrylamido chloride, vinylbenzyl trimethyl ammonium chloride.

More preferred cationic monomers include trimethyl ammonium propyl(meth)acrylamido chloride.

Examples of monomers bearing a negative charge include alpha ethylenically unsaturated monomers comprising a phosphate or phosphonate group, alpha ethylenically unsaturated monocarboxylic acids, monoalkylesters of alpha ethylenically unsaturated dicarboxylic acids, monoalkylamides of alpha ethylenically unsaturated dicarboxylic acids, alpha ethylenically unsaturated compounds comprising a sulphonic acid group, and salts of alpha ethylenically unsaturated compounds comprising a sulphonic acid group.

Preferred monomers with a negative charge include acrylic acid, methacrylic acid, vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid, 2-sulphoethyl methacrylate, salts of 2-sulphoethyl methacrylate, acrylamido-2-methylpropanesulphonic acid (AMPS), salts of acrylamido-2-methylpropanesulphonic acid, and styrenesulphonate (SS).

Examples of nonionic monomers include vinyl acetate, amides of alpha ethylenically unsaturated carboxylic acids, esters of an alpha ethylenically unsaturated monocarboxylic acids with an hydrogenated or fluorinated alcohol, polyethylene oxide (meth)acrylate (i.e. polyethoxylated (meth)acrylic acid), monoalkylesters of alpha ethylenically unsaturated dicarboxylic acids, monoalkylamides of alpha ethylenically unsaturated dicarboxylic acids, vinyl nitriles, vinylamine amides, vinyl alcohol, vinyl pyrolidone, and vinyl aromatic compounds.

Preferred nonionic monomers include styrene, acrylamide, methacrylamide, acrylonitrile, methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, 2-ethyl-hexyl methacrylate, 2-hydroxyethylacrylate and 2-hydroxyethylmethacrylate.

The anionic counterion (X—) in association with the synthetic cationic polymers may be any known counterion so long as the polymers remain soluble or dispersible in water, in the shampoo composition, or in a coacervate phase of the shampoo composition, and so long as the counterions are physically and chemically compatible with the essential components of the shampoo composition or do not otherwise unduly impair product performance, stability or aesthetics. Non limiting examples of such counterions include halides (e.g., chlorine, fluorine, bromine, iodine), sulfate and methylsulfate.

Optional Ingredients

The shampoo composition may further comprise optional ingredients selected from the group consisting of oily conditioning agents, hydrocarbon oils, polyolefins, fatty esters, fluorinated conditioning compounds, fatty alcohols, quaternary ammonium compounds, polyethylene glycols, anti-dandruff actives, anti-microbial actives, inorganic or synthetic particles, opacifying agents, suspending agents, propellants, paraffinic hydrocarbons, mono or divalent salts, fragrances, vitamins, chelating agents, colorants, pigments, dyes, phase separation initiators such as electrolytes, and mixtures thereof. These optional components are described in detail in U.S. Patent Publication No. 2003/0223951A1. Such optional ingredients may be present in an amount of from about 0.1% to about 5% by weight of the shampoo composition.

Silicone Conditioning Agent

If oily conditioning agents are included, they are preferably in the form of a water-insoluble silicone conditioning agent. The silicone conditioning agent may comprise volatile silicone, non-volatile silicone, or combinations thereof. Preferred are non-volatile silicone conditioning agents. If volatile silicones are present, it will typically be incidental to their use as a solvent or carrier for commercially available forms of non-volatile silicone materials, such as silicone gums and resins. The silicone conditioning agent particles may be in the form of silicone resins, or they may be in the form of a silicone fluid (ie. dimethicone droplets).

Non-limiting examples of suitable silicone conditioning agents, and optional suspending agents for the silicone, are described in U.S. Reissue Pat. No. 34,584, U.S. Pat. Nos. 5,104,646, and 5,106,609. The silicone conditioning agents for use in the compositions preferably have a viscosity, as measured at 25° C., of from about 20 to about 2,000,000 centistokes (“csk”), more preferably from about 1,000 to about 1,800,000 csk, even more preferably from about 5,000 to about 1,500,000 csk, more preferably from about 10,000 to about 1,000,000 csk.

In one embodiment, at least 50% of the silicone conditioning agent particles present in the composition has a particle size of from about 1 μm to about 50 μm. In another embodiment, at least 50% of the silicone conditioning agent particles present in the composition has a particle size of from about 100 nm to about 1 μm. In yet another embodiment, at least 50% of the silicone conditioning agent particles present in the composition has a particle size of less than about 100 nm. Particle size is measured using a Partica LA-950®, according to the usage instructions provided by its manufacturer, Horiba.

Non-volatile silicone oils suitable for use in the compositions may be selected from organo-modified silicones and fluoro-modified silicones. In one embodiment, the non-volatile silicone oil is an organo-modified silicone which comprises an organo group selected from the group consisting of alkyl groups, alkenyl groups, hydroxyl groups, amine groups, quaternary groups, carboxyl groups, fatty acid groups, ether groups, ester groups, mercapto groups, sulfate groups, sulfonate groups, phosphate groups, propylene oxide groups, and ethylene oxide groups.

In a preferred embodiment, the non-volatile silicone oil is polydimethylsiloxane.

Silicone fluids suitable for use in the compositions are disclosed in U.S. Pat. Nos. 2,826,551; 3,964,500; and 4,364,837, British Patent No 849,433, and Silicon Compounds, Petrarch Systems, Inc. (1984).

### Method of Manufacture

The compositions, in general, may be made by mixing together at elevated temperature, e.g., about 72° C., water and surfactants along with any solids (e.g. amphiphiles) that need to be melted, to speed mixing into the personal cleansing composition. The ingredients are mixed thoroughly at the elevated temperature and then cooled to ambient temperature. Additional ingredients, including electrolytes, polymers, and particles, may be added to the cooled product. The silicone may be emulsified at room temperature in concentrated surfactant and then added to the cooled product.

### Preparation of Oxidatively Dyed Hair Switches and Comparative Data

Relative to the data below, the evaluated hair samples (“switches”) are prepared and measured according to the following techniques:

For each grouping below, a commercially available Nice n' Easy® hair color is applied to 3 hair switches of the same type (ie. light brown virgin hair), according to the directions provided with the products. After treatment with the hair dye product, the switches are allowed to dry. Each hair switch weighs 10 grams. The tabulated readings below represent the average of 3 total readings per hair switch, prior to, and after application of the respectively tabulated shampoo compositions. Accordingly the difference in color change is calculated based upon the average of 3 readings taken prior to treatment with the shampoo composition, being compared to the average of 3 readings taken after treatment with the shampoo composition. The technique for treating the switches with a shampoo composition is discussed hereinbelow.

After the 3 first readings are taken of the colored hair switches, the switches are each treated with a different shampoo composition represented in the tabulated data. One switch is treated with the shampoo composition of “Homopolymer Example #11” of the table below. Another is treated with the shampoo composition designated “NC”, which is defined hereinafter. A final switch is treated with “APA”, also defined herein after. Treatment of the switches involves massaging each shampoo composition into each respective switch of hair, with sufficient water to cause lathering as the shampoo is massaged into the switch. When the entire switch has been contacted with the lathering composition, it is rinsed with water. This wash/rinse cycle is repeated 10 times for each hair switch. The final 3 measurements are taken after the switches are allowed to dry, following the 10^{th} cycle.

All measurements (color change readings) are taken on a Datacolor Mercury D8 Spectrophotometer, using Diffuse Light (Integrating sphere) CIELabCh data, under Specular Excluded conditions. Results of each test are displayed in the Color Difference Report (CIElabch D65/10) field described on pages 22 and 23 of the Datacolor Maestro User's Guide © Datacolor 2004. The data is further recorded in terms of ΔE=\sqrt{(L1−L2)²+(a1−a2)²+(b1−b2)²}. ΔE=\sqrt{(L1−L2)²+(a1−a2)²+(b1−b2)²} is well known in the art for color comparison analysis, and is discussed in detail in European Patent No. 0747759 to Giorgianni et al.

The tables below (Color Fade ΔE Table 1, Color Fade ΔE Table 2, and Color Fade ΔE Table 3) are illustrative of the color loss prevention benefit of the shampoo compositions of the present invention. Homopolymer Example #11* (defined hereinbelow) is compared to NC and APA, and demonstrates the color loss prevention benefit associated with the shampoo composition of the present invention vs. NC and APA. Homopolymer Example #11 demonstrates a significant reduction of color loss vs. NC and APA, according to Color Fade ΔE Table 1, and Color Fade ΔE Table 2. Color Fade ΔE Table 3 shows an insignificant difference between Example #11 vs. NC, while showing an advantage vs. APA. It is believed that Color Fade ΔE Table 3 demonstrates the general resilience of Brown hair color relative to color loss resistance rather than any advantage or deficiency of the present invention. It is generally known in the art that Blonde tones, and to even a greater extent, Red tones are highly susceptible to color loss, while “darker” tones such as Black or Brown are less susceptible to color loss. Accordingly, the results of Color Fade ΔE Table 3 may be expected to be less pronounced than comparisons of other hair color shades. Therefore, Color Fade ΔE Table 1 and Color Fade ΔE Table 2 are believed to be illustrative of the color loss prevention benefit of the present invention.

Color Fade ΔE Table 1
Hair Switches Colored with Nice &
Easy ® Blonde #106 ®

| 10 Cycles | ΔE |
|---|---|
| Homopolymer Example #11 | 2.84 |
| NC | 4.25 |
| APA | 3.54 |

Color Fade ΔE Table 2
Hair Switches Colored with Nice &
Easy ® Red #110 ®

| 10 Cycles | ΔE |
|---|---|
| Homopolymer Example #11 | 2.85 |
| NC | 3.87 |
| APA | 3.97 |

Color Fade ΔE Table 3
Hair Switches Colored with Nice &
Easy ® Brown #118 ®

| 10 Cycles | ΔE |
|---|---|
| Homopolymer Example #11 | 2.85 |
| NC | 2.83 |
| APA | 3.55 |

Comparative Product Formulas

| | NC | APA |
|---|---|---|
| Ammonium Laureth Sulfate AE3S (25%) | 7.90 | 8.50 |
| Sodium Lauryl Sulfate SLS (25%) | 5.70 | |
| Ammonium Lauryl Sulfate ALS (25%) | | 7.50 |
| Cetyl Alcohol | | 0.90 |
| Cocamidopropyl Betaine | 2.10 | |
| Cocamide MEA | 0.5 | 0.80 |
| EGDS | | 1.50 |
| Pefume She Is Brilliant | | 0.70 |
| Puresyn 3E20 | | 0.10 |
| Polydecene Puresyn 6 | | 0.30 |
| Viscasil 300,000 | | 1.35 |
| DL-Panthenol 50% Solution | | 0.03 |
| DL-Panthenyl Ethyl Ether | | 0.03 |
| UCARE LR 400 | | 0.50 |
| PEG 7M | | 0.10 |
| Sodium Citrate | | 0.40 |
| Citric Acid | 0.20 | 0.04 |
| Kathon CG | 0.00045 | 0.000500 |
| Disodium EDTA | | 0.10 |
| Tetrasodium EDTA | 0.16 | |
| NaCl | 1.00 | |
| Sodium Benzoate | 0.25 | 0.25 |
| Water | Balance | Balance |

All exemplified amounts are listed as weight percents and exclude minor materials such as diluents, preservatives, color solutions, imagery or conceptual ingredients, botanicals, and so forth, unless otherwise specified.

The following examples are representative of suitable shampoo compositions for use in the method of preventing color loss from oxidatively dyed hair according to the present invention:

### NON-LIMITING EXAMPLES

Hompolymers

| | EXAMPLE COMPOSITION | | | | | | | | | | |
|---|---|---|---|---|---|---|---|---|---|---|---|
| | 1 | 2 | 3 | 4 | 5 | 6 | 7 | 8 | 9 | 10 | 11* |
| Ammonium Laureth Sulfate (AE₃S) | 6.50 | 10.00 | | | 6.50 | 7.5 | 7.5 | | | | 10.00 |
| Ammonium Lauryl Sulfate (ALS) | 8.10 | 6.00 | | | 5.50 | 6.5 | 6.5 | | | | 6.00 |
| Sodium Laureth Sulfate (SE₃S) | | | 6.50 | 6.50 | | | | 6.50 | 6.50 | 6.50 | |
| Sodium Lauryl Sulfate (SLS) | 1.40 | | 5.50 | 5.50 | | | | 5.50 | 5.50 | 5.50 | |
| Sodium Lauroamphoacetate⁽¹⁴⁾ | | | | | 2.00 | | | | 2.00 | | |
| Laureth-4 | | | | | | | | | | | 0.9 |
| Cocaminopropionic Acid⁽¹⁵⁾ | | | | 1.00 | | | | | | | |
| Cocamidopropyl Betaine⁽¹⁶⁾ | | | | 1.00 | | | | | | | |
| Cocamide MEA | 1.00 | 0.80 | 0.80 | 0.80 | 0.80 | 0.80 | 0.80 | 0.80 | 0.80 | 0.80 | |
| Cetyl Alcohol | 0.35 | 0.90 | 0.60 | 0.60 | 0.60 | 0.60 | 0.60 | 0.60 | 0.60 | 0.60 | |
| Lauryl Alcohol | 0.20 | | 0.35 | 0.35 | 0.35 | | | 0.35 | 0.35 | 0.35 | |
| Dihydrogenated Tallowamidoethyl | | | 0.15 | 0.15 | 0.15 | 0.15 | 0.15 | 0.15 | 0.15 | 0.15 | |
| Hydroxyethylmonium Methosulfate⁽¹⁷⁾ | | | | | | | | | | | |
| Disodium EDTA Dihydrate | | | | | | | | | | | 0.13 |
| 1-Propanaminium, N,N,N-trimethyl-3- | 0.40⁽¹⁾ | | | | | | | | | | |
| [(2-methyl-1-oxo-2-propenyl)amino]-, | | | | | | | | | | | |
| chloride; | | | | | | | | | | | |
| (Poly(Methacrylamidopropyl trimethyl | | | | | | | | | | | |
| ammonium chloride))^{(1,2)} | | | | | | | | | | | |
| Methacryloamidopropyl-pentamethyl- | | | | | | 0.40 | | | | | |
| 1,3-propylene-2-ol-ammonium | | | | | | | | | | | |
| dichloride⁽³⁾ | | | | | | | | | | | |
| N,N,N,N′,N′,N″,N″-heptamethyl-N″-3- | | | | | | | 0.40 | | | | |
| (1-oxo-2-methyl-2- | | | | | | | | | | | |
| propenyl)aminopropyl-9- | | | | | | | | | | | |
| oxo-8-azo-decane-1,4,10-triammonium | | | | | | | | | | | |
| trichloride(18) | | | | | | | | | | | |
| diallyldimethyl ammonium chloride⁽⁴⁾ | | 0.50 | 0.40 | 0.50 | 0.40 | | | 0.40 | | | 0.20 |
| [3-methacryloylamino)propyl] | | | | | | | | | 0.40 | | |
| dimethylethylammonium ethylsulfate | | | | | | | | | | | |
| homopolymer⁽⁵⁾ | | | | | | | | | | | |
| [(2- | | | | | | | | | | 0.40 | |
| methacryloyloxy)ethyl]trimethylammonium | | | | | | | | | | | |
| methylsulfate homopolymer⁽⁶⁾ | | | | | | | | | | | |
| Ethylene Glycol Distearate | | 1.50 | 1.50 | 1.50 | 1.50 | 1.50 | 1.50 | 1.50 | 1.50 | 1.50 | |
| Trihydroxystearin⁽⁷⁾ | 0.25 | | | | | | | | | | 0.1 |
| Polyethylene Glycol (14000)⁽⁸⁾ | | | 0.17 | 0.17 | 0.17 | 0.17 | 0.17 | 0.17 | 0.17 | 0.17 | |
| Fragrance | 0.55 | 0.70 | 0.55 | 0.55 | 0.55 | 0.55 | 0.55 | 0.55 | 0.55 | 0.55 | |
| Sodium Chloride | 0.30 | 1.30 | 0.80 | 0.80 | 0.80 | 0.80 | 0.80 | 0.80 | 0.80 | 0.80 | 0.25 |
| Methylchloroisothiazolinone | | | | | | | | | | | 0.03 |
| Ammonium Xylenesulfonate | 1.00 | | | | | | | | | | |
| Citric Acid | 0.04 | 0.04 | 0.04 | 0.04 | 0.04 | 0.04 | 0.04 | 0.04 | 0.04 | 0.04 | 0.04 |
| Sodium Citrate | 0.40 | 0.40 | 0.40 | 0.40 | 0.40 | 0.40 | 0.40 | 0.40 | 0.40 | 0.40 | 0.4 |
| Sodium Benzoate | 0.25 | 0.25 | 0.25 | 0.25 | 0.25 | 0.25 | 0.25 | 0.25 | 0.25 | 0.25 | 0.25 |
| Ethylene Diamine Tetra Acetic Acid | 0.10 | 0.10 | 0.10 | 0.10 | 0.10 | 0.10 | 0.10 | 0.10 | 0.10 | 0.10 | |
| Dimethicone^{(9,10,11)} | | 2.35⁽⁹⁾ | 0.50⁽⁹⁾ | 2.00⁽¹⁰⁾ | 2.00⁽¹¹⁾ | 0.80⁽⁹⁾ | 0.80⁽⁹⁾ | 0.50⁽⁹⁾ | 0.50⁽⁹⁾ | | 1.0⁽¹⁰⁾ |
| Polydecene⁽¹²⁾ | | 0.40 | | | | | | | | | |
| Trimethylolpropane | | 0.10 | | | | | | | | | |
| Tricaprylate/Tricaprate⁽¹³⁾ | | | | | | | | | | | |
| Perfume | | | | | | | | | | | 0.6 |
| Panthenol | | | | | | | | | | | 0.03 |
| Panthenyl Ethyl Ether | | | | | | | | | | | 0.03 |
| Water and Minors (QS to 100%) | | | | | | | | | | | |

⁽¹⁾HMW MAPTAC (Rhodia) [charge density = 4.5 meq/g, molecular weight ~860,000]
⁽²⁾HHMW MAPTAC (Rhodia) [charge density = 4.5 meq/g, molecular weight ~1,500,000]
⁽³⁾Diquat (Rhodia) [charge density = 5.60 meq/g, molecular weight ~252,000]
⁽⁴⁾DADMAC (Rhodia) [charge density = 6.2 meq/g, molecular weight ~1,200,000]
⁽⁵⁾Homopolymer of DMAPMA + DES (Rhodia) [charge density = 3.09 meq/g, molecular weight ~180,000]
⁽⁶⁾Homopolymer of METAMS (Rhodia) [charge density = 3.53 meq/g, molecular weight ~313,000]
⁽⁷⁾Thixcin R (Rheox)
⁽⁸⁾PEG 14M (Dow Chemical)
⁽⁹⁾Viscasil 330M (General Electric Silicones)
⁽¹⁰⁾Dow Corning ® 1664 Emulsion (Dow Corning)
⁽¹¹⁾Dow Corning ® 2-1865 Microemulsion (Dow Corning)
⁽¹²⁾Puresyn 6, MCP-1812 (Mobil)
⁽¹³⁾Mobil P43 (Mobil)
⁽¹⁴⁾Miranol Ultra L32 (Rhodia)
⁽¹⁵⁾MACKAM 151C (McIntyre)
⁽¹⁶⁾Tegobetaine F-B (Goldschmidt)
⁽¹⁷⁾Varisoft 110 (Witco)
⁽¹⁸⁾Triqaut (Rhodia) [charge density = 6.07]

Copolymers

| | EXAMPLE COMPOSITION | | | | | | | | |
|---|---|---|---|---|---|---|---|---|---|
| | 11 | 12 | 13 | 14 | 15 | 16 | 17 | 18 | 19 |
| Ammonium Laureth Sulfate (AE₃S) | 10.00 | 10.00 | | | | | | | |
| Ammonium Lauryl Sulfate (ALS) | 6.00 | 6.00 | | | | | | | |
| Sodium Laureth Sulfate (SE₃S) | | | 6.50 | 6.50 | 6.50 | 6.50 | 6.50 | 6.50 | 6.50 |
| Sodium Lauryl Sulfate (SLS) | | | 5.50 | 5.50 | 5.50 | 5.50 | 5.50 | 5.50 | 5.50 |
| Sodium Lauroamphoacetate⁽¹⁵⁾ | | | | | | | | | 2.00 |
| Cocaminopropionic Acid⁽¹⁶⁾ | | | | | | | | 1.00 | |
| Cocamidopropyl Betaine⁽¹⁷⁾ | | | | | | | | 1.00 | |
| Cocamide MEA | 0.80 | 0.80 | 0.80 | 0.80 | 0.80 | 0.80 | 0.80 | 0.80 | 0.80 |
| Cetyl Alcohol | 0.90 | 0.90 | 0.60 | 0.60 | 0.60 | 0.60 | 0.60 | 0.60 | 0.60 |
| Lauryl Alcohol | | | 0.35 | 0.35 | 0.35 | 0.35 | 0.35 | 0.35 | 0.35 |
| Dihydrogenated Tallowamidoethyl | | | 0.15 | 0.15 | 0.15 | 0.15 | 0.15 | 0.15 | 0.15 |
| Hydroxyethylmonium Methosulfate⁽¹⁸⁾ | | | | | | | | | |
| Trimethylammoniopropylmethacrylamide | 1.00⁽¹⁾ | 0.50⁽²⁾ | 0.40⁽³⁾ | 0.05⁽²⁾ | 0.40⁽²⁾ | | | | |
| chloride-N-Hydroxyethyl acrylate copolymer^{(1,2,3)} | | | | | | | | | |
| Trimethylammoniopropylmethacrylamide | | | | | | 0.40⁽⁴⁾ | 0.40⁽⁵⁾ | | |
| chloride-N-vinylpyrrolidone copolymer^{(4,5)} | | | | | | | | | |
| Dimethyldiallyl ammonium chloride-N-b- | | | | | | | | 0.40 | |
| Hydroxyethyl acrylate copolymer⁽⁶⁾ | | | | | | | | | |
| Trimethylammoniopropylmethacrylamide | | | | | | | | | 0.40 |
| chloride-N- | | | | | | | | | |
| Methacrylamidopropyldimethylammonium | | | | | | | | | |
| methylcarboxylate copolymer⁽⁷⁾ | | | | | | | | | |
| Ethylene Glycol Distearate | 1.50 | 1.50 | | 1.50 | 1.50 | 1.50 | 1.50 | 1.50 | 1.50 |
| Trihydroxystearin⁽⁸⁾ | | | 0.25 | | | | | | |
| Polyethylene Glycol (14000)⁽⁹⁾ | | | 0.17 | 0.17 | 0.17 | 0.17 | 0.17 | 0.17 | 0.17 |
| Fragrance | 0.55 | 0.70 | 0.55 | 0.55 | 0.55 | 0.55 | 0.55 | 0.55 | 0.55 |
| Sodium Chloride | 1.00 | 1.30 | 0.80 | 0.80 | 0.80 | 0.80 | 0.80 | 0.80 | 0.80 |
| Ammonium Xylenesulfonate | | | | | | | | | |
| Citric Acid | 0.04 | 0.04 | 0.04 | 0.04 | 0.04 | 0.04 | 0.04 | 0.04 | 0.04 |
| Sodium Citrate | 0.40 | 0.40 | 0.40 | 0.40 | 0.40 | 0.40 | 0.40 | 0.40 | 0.40 |
| Sodium Benzoate | 0.25 | 0.25 | 0.25 | 0.25 | 0.25 | 0.25 | 0.25 | 0.25 | 0.25 |
| Ethylene Diamine Tetra Acetic Acid | 0.10 | 0.10 | 0.10 | 0.10 | 0.10 | 0.10 | 0.10 | 0.10 | 0.10 |
| Dimethicone^{(10,11,12)} | 1.35⁽¹⁰⁾ | 1.00⁽¹⁰⁾ | | 0.50⁽¹⁰⁾ | 0.50⁽¹⁰⁾ | 0.50⁽¹⁰⁾ | 0.50⁽¹⁰⁾ | 2.00⁽¹¹⁾ | 2.00⁽¹²⁾ |
| Polydecene⁽¹³⁾ | 0.40 | 0.40 | | | | | | | |
| Trimethylolpropane Tricaprylate/Tricaprate⁽¹⁴⁾ | 0.10 | 0.10 | | | | | | | |
| Water and Minors (QS to 100%) | | | | | | | | | |

⁽¹⁾1:9 HEA:MAPTAC (Rhodia) [charge density = 4.29 meq/g, molecular weight ~276,000]
⁽²⁾3:7 HEA:MAPTAC (Rhodia) [charge density = 3.71 meq/g, molecular weight ~648,000]
⁽³⁾3:7 HEA:MAPTAC (Rhodia) [charge density = 3.71 meq/g, molecular weight ~1,200,000]
⁽⁴⁾1:9 VP:MAPTAC (Rhodia) [charge density = 4.30 meq/g, molecular weight ~242,000]
⁽⁵⁾3:7 VP:MAPTAC (Rhodia) [charge density = 3.74 meq/g, molecular weight ~503,000]
⁽⁶⁾1:9 HEA:DMDAAC (Rhodia) [charge density = 5.75 meq/g, molecular weight ~274,000]
⁽⁷⁾1:1 AP:MAPTAC (Rhodia) [charge density = 3.95 meq/g, molecular weight ~243,000]
⁽⁸⁾Thixcin R (Rheox)
⁽⁹⁾PEG 14M (Dow Chemical)
⁽¹⁰⁾Viscasil 330M (General Electric Silicones)
⁽¹¹⁾Dow Corning ® 1664 Emulsion (Dow Corning)
⁽¹²⁾Dow Corning ® 2-1865 Microemulsion (Dow Corning)
⁽¹³⁾Puresyn 6, MCP-1812 (Mobil)
⁽¹⁴⁾Mobil P43 (Mobil)
⁽¹⁵⁾Miranol Ultra L32 (Rhodia)
⁽¹⁶⁾MACKAM 151C (McIntyre)
⁽¹⁷⁾Tegobetaine F-B (Goldschmidt)
⁽¹⁸⁾Varisoft 110 (Witco)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for preventing color loss from oxidatively dyed hair comprising the steps of:
a) contacting said hair with a shampoo composition, said shampoo comprising:
i from about 5% to about 50% of an anionic surfactant;
ii from about 0.025% to about 5% by weight of a synthetic cationic polymer having a cationic charge density of at least about 3 meq/gm, wherein said synthetic cationic polymer form lyotropic liquid crystals upon combination with said anionic surfactant; and
iii water; and
b) rinsing said composition from said hair.

2. A method according to claim 1, wherein said synthetic cationic polymer has a cationic charge density of at least about 5 meq/gm.

3. A method according to claim 1, wherein said cationic polymer is diallyldimethyl ammonium chloride.

4. A method according to claim 1, wherein said shampoo composition further comprises a conditioning agent selected from the group consisting of oily conditioning agents, hydrocarbon oils, polyolefins, fatty esters, fluorinated conditioning compounds, fatty alcohols, quaternary ammonium compounds, polyethylene glycols, and mixtures thereof.

5. A method according to claim 4, wherein said oily conditioning agent is a silicone conditioning agent, wherein at least 50% of said silicone conditioning agents have a particle size of from about 1 μm to about 50 μm.

6. A method according to claim 4, wherein said oily conditioning agent is a silicone conditioning agent, wherein at least 50% of said silicone conditioning agents have a particle size of from about 100 nm to about 1 μm.

7. A method according to claim 4, wherein said oily conditioning agent is a silicone conditioning agent, wherein at least 50% of said silicone conditioning agents have a particle size of less than about 100 nm.

8. A method according to claim 4, wherein said oily conditioning agent is polydimethylsiloxane.

9. A method according to claim 1, wherein said shampoo composition further comprises from about 0.1% to about 5%, by weight of electrolytes.

10. An article of manufacture useful for preventing color loss from oxidatively dyed hair comprising:
(a) a package;
(b) said package comprising a shampoo composition, wherein said shampoo composition comprises lyotropic liquid crystals; and
(c) information in association with said package comprising an instruction to use said shampoo composition to prevent color loss from oxidatively dyed hair.

11. An article of manufacture according to claim 10, wherein said information further comprises information which communicates to a consumer that the shampoo composition provides hair with a protective hydrophobic layer.

12. An article of manufacture according to claim 10, wherein said information is indicia is selected from the group consisting of words, pictures, symbols, or mixtures thereof.

13. A method for promoting the sale of the article of claim 10, comprising the steps of:
(a) displaying the shampoo product in a retail store; and
(b) providing promotional materials to consumers;
wherein said promotional materials comprise information which communicates to a consumer that said shampoo composition's ability to prevent color loss from oxidatively dyed hair.

14. A method according to claim 13, wherein said promotional materials further comprise samples of said shampoo composition.

15. A method according to claim 13, wherein said promotional materials further comprise one or more discount coupons.

16. A method according to claim 13, wherein said promotional materials are further provided to hair styling salons.
